(19) United States
(12) Patent Application Publication
(10) Pub. No.: US 2019/0370844 A1
(43) Pub. Date: Dec. 5, 2019

(54) SYSTEM, METHOD, AND APPARATUS FOR RANKING AND REWARDING USERS THAT COMPLETE REVIEWS

(71) Applicant: RAADZ INC., Louisville, KY (US)

(72) Inventor: Matthew Clark Miller, Louisville, KY (US)

(21) Appl. No.: 16/426,590

(22) Filed: May 30, 2019

Related U.S. Application Data
(60) Provisional application No. 62/678,691, filed on May 31, 2018.

(51) Int. Cl. G06Q 30/02

(52) U.S. Cl. CPC G06Q 30/0218

(57) ABSTRACT

The present disclosure relates to a system, method, and apparatus that incentivizes users to give thoughtful answers when completing reviews by only rewarding a portion of users that complete the reviews. An item (e.g., an advertisement, product design, or logo) may be presented to a number of users along with a query about the item. Answers may be received from the users and a comparison value may be calculated for the answers. A deviation value may then be determined for each user between the answer the user provided and the comparison value. The number of users may then be ranked according to their respective deviation values with a lower deviation value corresponding to a lower ranking. One or more users with the lowest rankings may then be provided with a reward.

### PRIORITY CLAIM

The present application claims priority to and the benefit of U.S. Provisional Patent Application No. 62/678,691 filed on May 31, 2018, the entirety of which is incorporated herein by reference.

### BACKGROUND

Advertisements can be seen and heard everywhere. For instance, advertisements can be in newspapers, magazines, on television, websites, radio, billboards, sports arenas, etc. Generally, advertisers spend billions of dollars annually on advertisements. However, frequently these advertisements go unnoticed or unviewed. Many individuals may change the channel or station, switch their attention to something else, close out of pop-up ads, etc. instead of viewing the advertisements. Because the audience may not be paying attention, advertisements may not effectively be reaching their intended audience.

Further, advertisers may desire feedback from viewers who do view their advertisements. However, users may not want to participate in telephone surveys, mail surveys, or online surveys as they may be time consuming, and require individuals to mail documents. Or, if the users do participate in the surveys, they may give rushed answers to complete the survey as quickly as possible. Often, rushed answers do not provide an accurate representation of the viewers' opinion regarding an advertisement.

Likewise, parties other than advertisers may desire feedback from the public regarding a variety of items. For example, a company may want to conduct market research on a new product design. Or, a company may be considering changing its logo and want feedback on which logo will best resonate with individuals. In another example, a company or organization may want thoughtful feedback on the quality of service they provide to individuals.

### SUMMARY

The present disclosure is directed to a system, method, and apparatus configured to rank and reward users that complete reviews. The disclosed system, method, and apparatus encourages individuals to complete reviews by incentivizing users with rewards, and allowing users to easily access items to be reviewed and answer questions using a website or web application. For example, the disclosed system, method, and apparatus may encourage individuals to view advertisements and participate in questioning regarding the viewed advertisements. The disclosed system, method, and apparatus may also incentivize users to provide thoughtful answers to survey questions, and avoid carelessness, by not rewarding all users who complete the survey.

In one embodiment, a method of rewarding users for completing reviews includes causing, via a processor, an item to be presented at a number of user devices to a number of users during a feedback session. The method then includes receiving, via the user devices, an answer value from each of the number of users in response to a query included in or regarding the item. A comparison value is then calculated, via the processor, for the answer values from the number of users. A deviation value is then determined, via the processor for each of the users, between the respective answer value for each user and the comparison value. The method then includes ranking, via the processor, the number of users based on their respective deviation values such that a lower ranking corresponds to a lower deviation value, and causing a reward to be provided to at least one user via the processor.

In another embodiment, an apparatus is provided for rewarding users for completing reviews including a processor and a memory storing instructions which, when executed by the processor, cause the processor to cause an item to be presented at a number of user devices to a number of users during a feedback session. The instructions may then cause the processor to receive, via the user devices, an answer value from each of the number of users in response to a query included in or regarding the item. The instructions may then cause the processor to calculate a comparison value for the answers values from the number of users. The processor then determines, for each of the users, a deviation value between the respective answer value for each user and the comparison value. The instructions then cause the processor to rank the number of users based on their respective deviation values such that a lower ranking corresponds to a lower deviation value, and to cause a reward to be provided to at least one user.

The advantages discussed herein may be found in one, or some, and perhaps not all of the embodiments disclosed herein. Additional features and advantages are described herein, and will be apparent from the following Detailed Description and the figures.

### BRIEF DESCRIPTION OF THE DRAWINGS

FIG. 1 illustrates an example diagram of a system for rewarding and ranking users that view advertisements, according to one aspect of the present disclosure.

FIG. 2 illustrates an example embodiment of an analysis server of the present disclosure.

FIG. 3 illustrates an example question user interface of a system for rewarding and ranking users that view advertisements, according to one aspect of the present disclosure.

FIG. 4 illustrates an example question user interface of a system for rewarding and ranking users that view advertisements, according to one aspect of the present disclosure.

FIG. 5 illustrates an example interface for rating advertisements, according to one aspect of the present disclosure.

FIG. 6 is an example advertiser platform interface for rewarding and ranking users that view advertisements, according to one aspect of the present disclosure.

FIG. 7 is a flowchart illustrating an example method for using a system for rewarding and ranking users that view advertisements, according to one aspect of the present disclosure.

FIG. 8 is an example network diagram of a system for rewarding and ranking users that view advertisements, according to one aspect of the present disclosure.

FIG. 9 is a flowchart illustrating an example method for using a system for rewarding and ranking users that view advertisements, according to one aspect of the present disclosure.

### DETAILED DESCRIPTION

The present disclosure relates in general to a method, system, and apparatus configured to rank and reward users that complete reviews of items (e.g., advertisements) by answering questions. While the disclosure discusses a single operator of a web platform to enable the viewing and answering of questions/queries relating to advertisements, the example method, system, and apparatus disclosed herein enables multiple entities, operators, managers, etc. to view/track/upload/manage/sell space on the web platform for obtaining feedback regarding advertisements. Further, while the disclosure discusses a single web platform to enable the viewing and answering of questions/queries relating to advertisements, the example method, system, and apparatus disclosed herein may be implemented on multiple web platforms to enable the viewing and answering of questions/queries relating to advertisements. The example method, system, and apparatus may be used for virtually any type of item a party desires a review of, such as an advertisement. The presently disclosed method, system, and apparatus may be used with virtually any type of advertisement, for example, billboards, television ads, radio ads, newspaper and magazine ads, internet ads, pop-up ads, direct mail advertising, posters, displays, signs, banner ads, etc.

It should be understood that while the presently disclosed method, system, and apparatus is described as being used only with feedback sessions for rating advertisements, the present disclosure may be used for other items that parties wish to receive thoughtful reviews for. For example, a party may wish to conduct a market review for a new product design and may present different alternative designs to the public in a survey format. In another example, a company may be considering changing its logo and may seek feedback from the public. In another example still, a company or organization may want thoughtful feedback on the service it provided to a group of individuals. It should be appreciated that these are merely examples, and there are many more instances in which a party may want to issue questions and incentivize thoughtful answers in response. Additionally, it should be appreciated that the described advantages herein of the disclosed system, method, and apparatus for advertisers can be correlated with the other described uses of the disclosed system, method, and apparatus.

Answering survey questions, if properly contemplated and truthfully answered, may often be time consuming and test the patience of participants in surveys and studies. However, these surveys, questionnaires, and focus groups may be invaluable to advertisers in developing advertisements, or selecting which advertisements or elements of advertisements to use. Focus groups also provide important feedback on released ad campaigns. The goal in using focus groups and questionnaires/surveys may be to make advertisements as appealing as possible prior to launch, so that advertisements reach and impact their target audience. Recently, advertisers or third party companies have been incentivizing participants of surveys with rewards, such as monetary incentives, for their time participating in these surveys. However, these programs and surveys frequently reward all participants, without analyzing the quality of their feedback. Therefore, many individuals may rush through the questions or discussion in order to quickly receive their reward, without providing truthful or thoughtful answers.

The provided system and method encourages individuals to participate using rewards, but may limit the number of participants that receive a reward. An example of the disclosed system, method, and apparatus rewards thoughtful and truthful answers, by rewarding individuals whose numerical answers fall closest to a comparison value calculated from the answers of all participants. The comparison value is meant to be a representation of a truthful or thoughtful answer. For example, the comparison value may be the average, median, or mode of all the answers received from users for a question in some embodiments. Therefore, in the example, as individuals answer survey questions relating to ads, they may more carefully and thoughtfully answer questions in order to analyze how the typical viewer or listener of an advertisement may think about a viewed advertisement in relation to a particular question. This is because only a portion of participants with answers closest to the comparison value may receive a reward.

Further, one feature of the present disclosure may include that the “correct” answers to the questions presented to participants are not known when the user answers questions related to the viewed advertisements. The user's answers may not be compared to right or wrong answers, but rather to the answers of other users/participants reviewing the same advertisements and being asked similar or identical questions. Therefore, a correct answer may be unknown until after all participants have submitted an answer. Once submitted, participants may then be ranked and compared to other users, and this ranking may play a role in the compensation and/or rewards received by participants.

Reference is made herein to items to be presented. As disclosed herein, items may include anything that a party wants rated or reviewed, such as advertisements, images, videos, text, product designs, company logos, movies, books, or anything else that a user can view. Items may also include a set of questions the party wants completed if there is not a tangible item an individual may view, such as a set of questions regarding the quality of service a company or organization provided a group of individuals. Reference is also made herein to a feedback session. As disclosed herein, a feedback session may include an individual completing a review on his or her own at any given time, an organized meeting of individuals for the purpose of completing one or more reviews, or any other period of time set aside for completing a review.

### System Embodiment

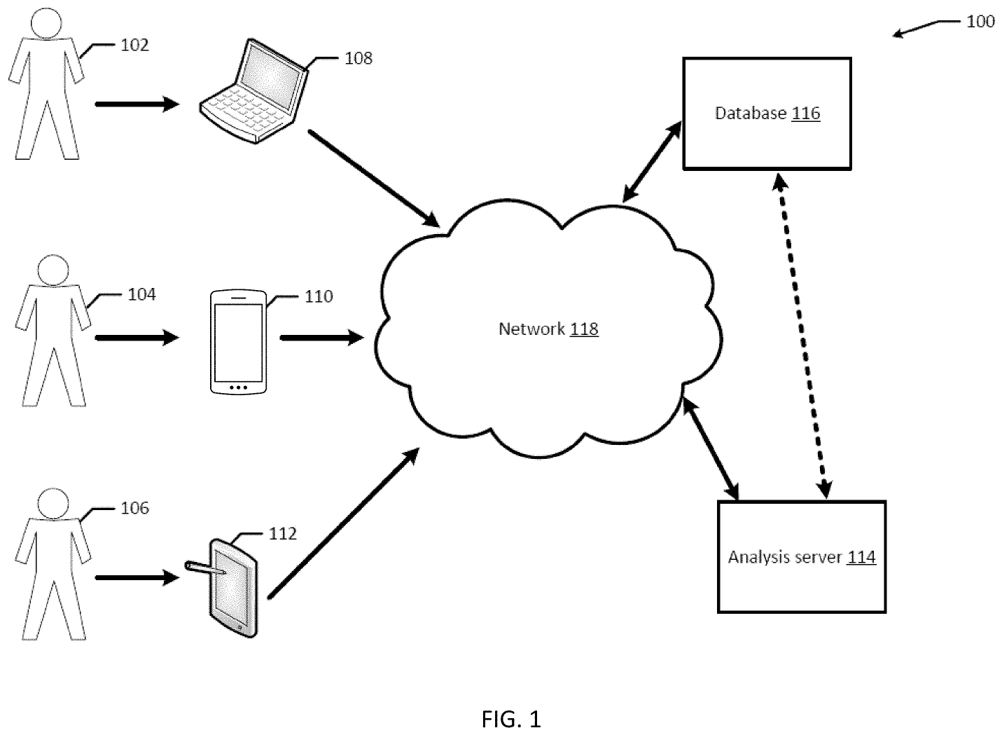

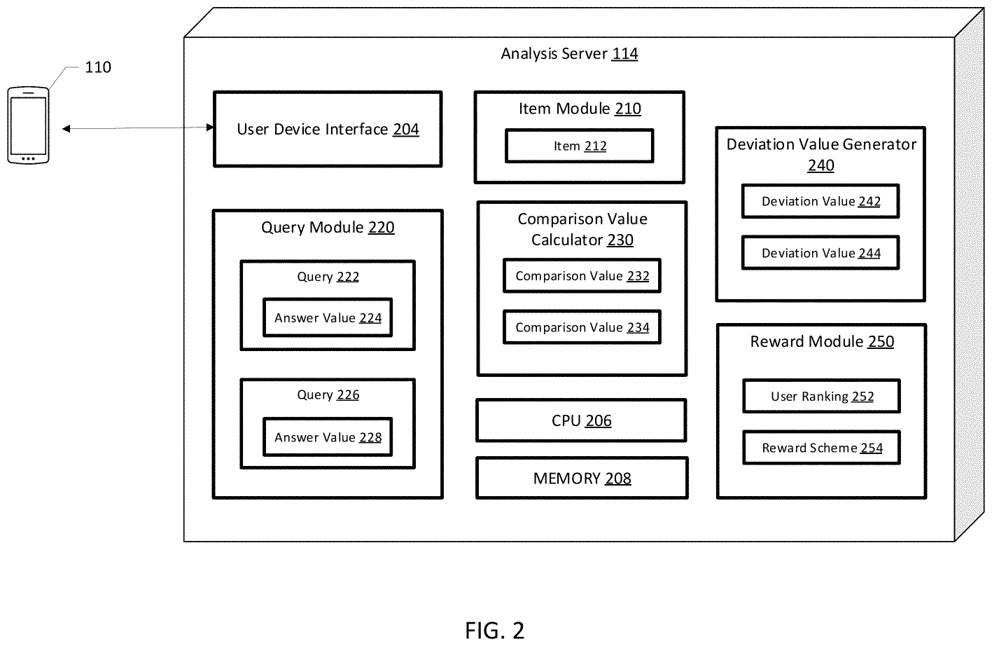

FIG. 1 shows an example diagram of a system 100 for ranking and rewarding users that view advertisements, according to one aspect of the present disclosure. In the example system 100, a user 102, a user 104, and a user 106 provide answer values 224, 228 (FIG. 2) into a device 108, 110, 112, such as a computer 108, a smart phone 110, or a tablet 112. It should be appreciated, however, that the device may be any device and is not limited to the devices disclosed herein. For example, the device may include any personal computer, smart phone, tablet, Personal Digital Assistant (PDA), television, gaming console, etc. The devices 108, 110, 112 may be configured to display to the users 102, 104, and 106 a website or application that users may access in order to provide their input (e.g., answer values 224, 228) regarding prompts or questions presented to users concurrently with, prior to, or after perceiving an advertisement.

The answer values 224, 228 received at the devices 108, 110, 112 may be directed to an analysis server 114 via a network 118. The network 118 may be wired or wireless. The analysis server 114 may execute calculations or instructions based on the answer values 224, 228 of the users 102, 104, 106. The calculations and instructions executed by the analysis server 114 determine which users 102, 104, 106 should be rewarded by comparing the answer values 224, 228 of the users 102, 104, 106 and ranking the users 102, 104, 106 based on how their answer values 224, 228 deviate from a comparison value 232, 234 (FIG. 2). It should be understood that each device 108, 110, 112 and the analysis server 114, may include a processor and/or memory.

As used herein, a memory device refers to a volatile or non-volatile memory device, such as RAM, ROM, EEPROM, or any other device capable of storing data. As used herein, physical processor or processor refers to a device capable of executing instructions encoding arithmetic, logical, and/or I/O operations. In one illustrative example, a processor may follow Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU). Processors may be interconnected using a variety of techniques, ranging from a point-to-point processor interconnect, to a system area network, such as an Ethernet-based network. In an example, the one or more physical processors may be in the system 100. In an example, all of the disclosed methods and procedures described herein can be implemented by the one or more processors. Further, the system 100 may be distributed over multiple processors, memories, and networks.

The analysis server 114 may be in communication with or coupled to a database 116. The database 116 may be connected to the network 118. The database 116 may be a memory device as described above. Database 116 may store a variety of information. Specifically, database 116 may store the answer values 224, 228 from the users 102, 104 and 106; the equations, calculations, or instructions used by the analysis server 114; the results of any analysis performed by the analysis server 114, etc. As indicated with the bi-directional dotted arrow between the analysis server 114 and the database 116, information may be communicated between them in both directions.

FIG. 2 shows an example diagram of the analysis server 114, according to an example embodiment of the present disclosure. The analysis server 114 includes different components that are representative of computational processes, routines, and/or algorithms. In some embodiments, the computational processes, routines, and/or algorithms may be specified in one or more instructions stored on a computer readable medium that, when executed by a processor of the analysis server 114, cause the analysis server 114 to perform the operations discussed below. For example, all or part of the computational processes, routines, and/or algorithms may be implemented by the CPU 206 and the memory 208. It should be appreciated that in other embodiments the components of the analysis server 114 may be combined, rearranged, removed, or provided on a separate device or server.

The analysis server 114 includes a user device interface 204 configured to be communicatively coupled to one or more devices 108, 110, 112. For example, the user device interface 204 is illustrated as being communicatively coupled to a device 110 (e.g., a smart phone). It should be appreciated, however, that the user device interface 204 may be communicatively coupled to any of the devices 108, 110, 112 discussed above. The analysis server 114 may also include an item module 210 which causes the processor of the analysis server 114 to present one or more items 212 to one or more users 102, 104, 106 via the user device interface 204 and a device 108, 110, 112. For the duration of this disclosure, item 212 will be referred to as ad 212 because the present system, method, and apparatus is explained in the context of reviewing advertisements. The analysis server 114 may also include a query module 220 which causes the processor of the analysis server 114 to present one or more queries 222, 226 to one or more users 102, 104, 106 via the user device interface 204 and a device 108, 110, 112. The query module 220 may also store the answer values 224, 228 provided by one or more users 102, 104, 106 in response to the one or more queries 222, 226. For example, the query module 220 may cause query 222 and query 226 to be presented to a user 102 and may store the answer value 224 and answer value 228 received in response to the queries 222 and 226, respectively.

The analysis server 114 may also include a comparison value calculator 230 which may analyze the answer values 224, 228 received from the users 102, 104, 106 to calculate a comparison value 232, 234 for each query 222, 226. The analysis server 114 may also include a deviation value generator 240 which compares the respective answer values 224, 228 from each user 102, 104, 106 with the calculated comparison value 232, 234 for a given query 222, 226 in order to generate deviation values 242, 244. The analysis server 114 may also include a reward module 250 which may compare the deviation values 242, 244 of the users 102, 104, 106 and generate a user ranking 252 where users 102, 104, 106 with lower deviation values 242, 244 have a lower ranking. The reward module 250 may also apply a stored reward scheme 254 to determine which users 102, 104, 106 will receive a reward for reviewing the ad 212.

### User Interface Embodiment

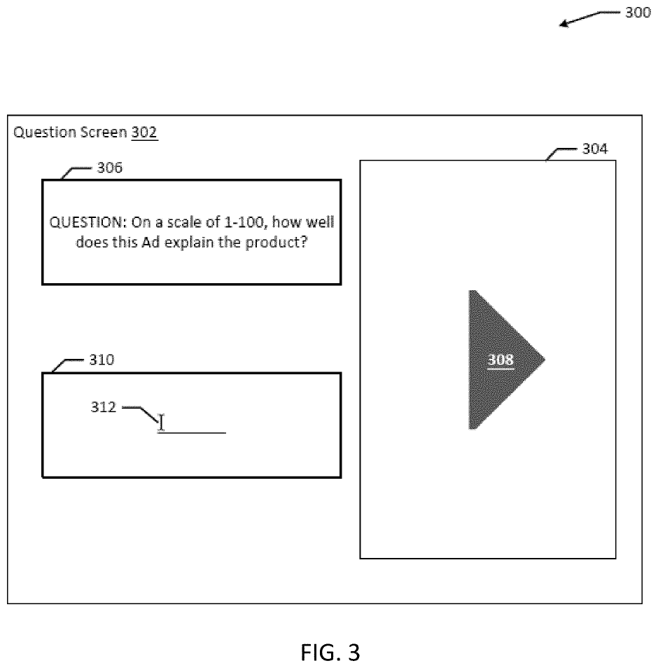

FIG. 3 illustrates an example question user interface of the example system 100 for rewarding and ranking users that view advertisements, according to one aspect of the present disclosure. Specifically, a device 300 may display a user interface such as the question interface 302 in order to prompt users 102, 104, 106 for their answer values 224, 228. In the illustrated example, a user 102, 104, 106 is presented with an advertisement 304 on the question interface 302. The advertisement 304 may be in the form of a video, as suggested by the play button 308 located on the advertisement 304. In an alternate example, the advertisement 304 may be any type of advertisement users 102, 104, 106 may encounter, including, banner ads, radio ads, television ads, displays, bill boards, newspaper and magazine ads, etc. There is no limit to the type of advertisement 304 that may be viewed, listened to, or encountered in the question interface 302.

After viewing the advertisement 304, the user 102, 104, 106 may read a question prompt 306 that will include a question for the user 102, 104, 106. In the illustrated example, the user 102, 104, 106 may enter his or her answer (i.e., an answer value 224, 228) in the answer user interface 310. This answer may be typed, as indicated by the text cursor 312 located in the answer user interface 310. In one example, the question prompt 306 and the answer user interface 310 may be displayed on the question interface 302 while the user 102, 104, 106 is watching the advertisement 304. In an alternative example, the question prompt 306 and the answer user interface 310 may not be presented to the user 102, 104, 106 until after the user 102, 104, 106 has finished watching the advertisement 304 or until the user 102, 104, 106 has indicated that he or she is ready to answer questions.

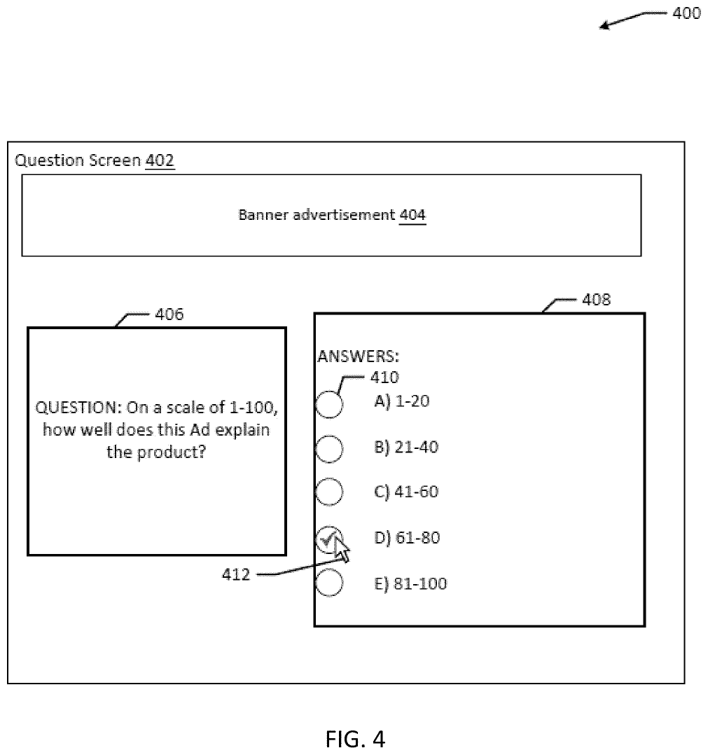

FIG. 4 shows an alternate example question user interface of the example system 100 for rewarding and ranking users that view advertisements, according to one aspect of the present disclosure. In the illustrated example, a device 400 may display a question interface 402 to a user 102, 104, 106. The question interface 402 may be presented to the user 102, 104, 106 in a mobile application, on a website, etc. The question interface 402 may include a banner advertisement 404. After viewing the banner advertisement 404, or simultaneously with viewing the banner advertisement 404, a user 102, 104, 106 may be presented with or prompted to answer a question in a question prompt 406. The user 102, 104, 106 may be presented with an answer user interface 408 containing multiple choice answers. Each answer in the answer user interface 408 may be associated with a bubble 410. A user 102, 104, 106 may select his or her answer (i.e., an answer value 224, 228) from the bubbles 410 using a cursor 412. For example, the user 102, 104, 106 is illustrated as having selected answer choice “D” in the answer user interface 408. In an alternate example, users 102, 104, 106 may be presented with boxes to check, may be able to select the answer itself, or may be presented with a sliding scale instead of being presented with the bubbles 410. In an alternate example, the answer user interface 408 may include a fill in or type in option in case none of the multiple choice answers are relevant to the user 102, 104, 106.

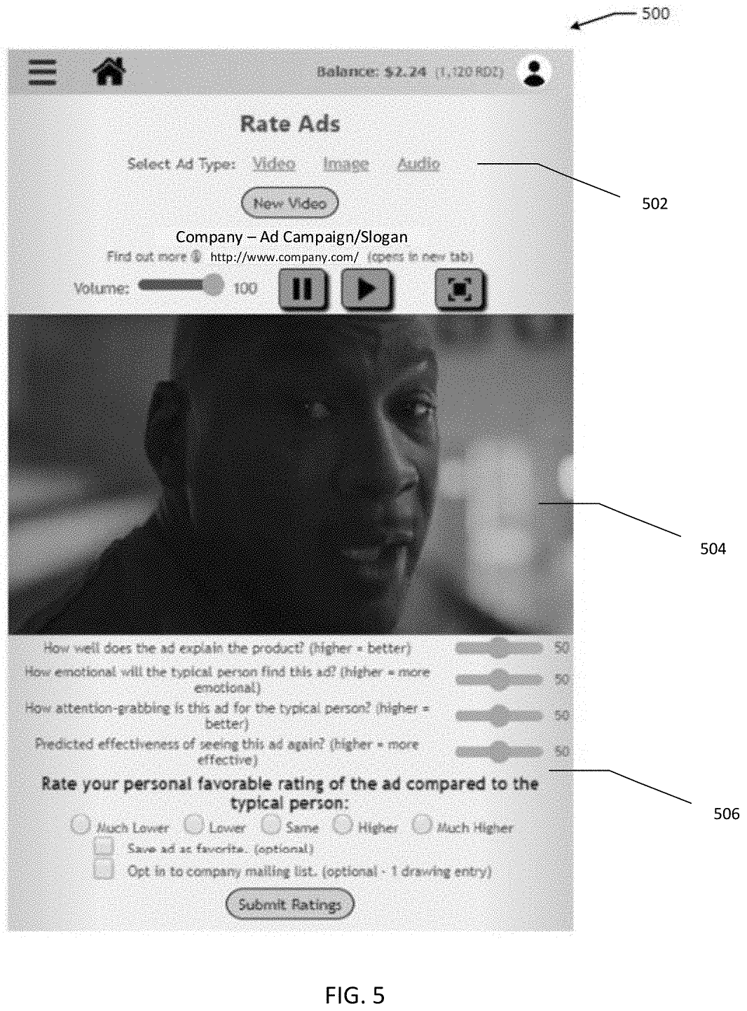

FIG. 5 illustrates an example interface 500 that a user 102, 104, 106 may be presented with on a device 108, 110, 112 for rating ads 212, according to one aspect of the present disclosure. The example interface 500 may include a select ad type user interface 502 at which users 102, 104, 106 may select which type of ad 212 they would like to rate. For example, in the illustrated example interface 500, users 102, 104, 106 have the option of a video, image, or audio ad 212. It should be appreciated, however, that the ad type may be any of the types of advertisements previously mentioned in this disclosure. The example interface 500 may also include an ad user interface 504 for displaying an ad 212. For example, a video is displayed on the example ad user interface 504, indicated by the volume scale, pause button, play button, and full size button. In various embodiments, a user 102, 104, 106 may select the full size button in order to make the ad 212 fit the entirety of the interface 500.

The example interface 500 may also include a query user interface 506 which may list any number of queries that a user 102, 104, 106 may answer about the ad 212. For example, in the illustrated query user interface 506 there are four queries with numerical sliding scales and one question with bubbles. It should be appreciated that the query user interface 506 may take any of the forms previously discussed in relation to the question interface 302 and the question interface 402. In some embodiments, the query user interface 506 may be inoperable until the user 102, 104, 106 completes viewing the ad 212. In other embodiments, the user 102, 104, 106 may be able to answer queries in the query user interface 506 while viewing the ad 212.

### Advertiser Interface Embodiment

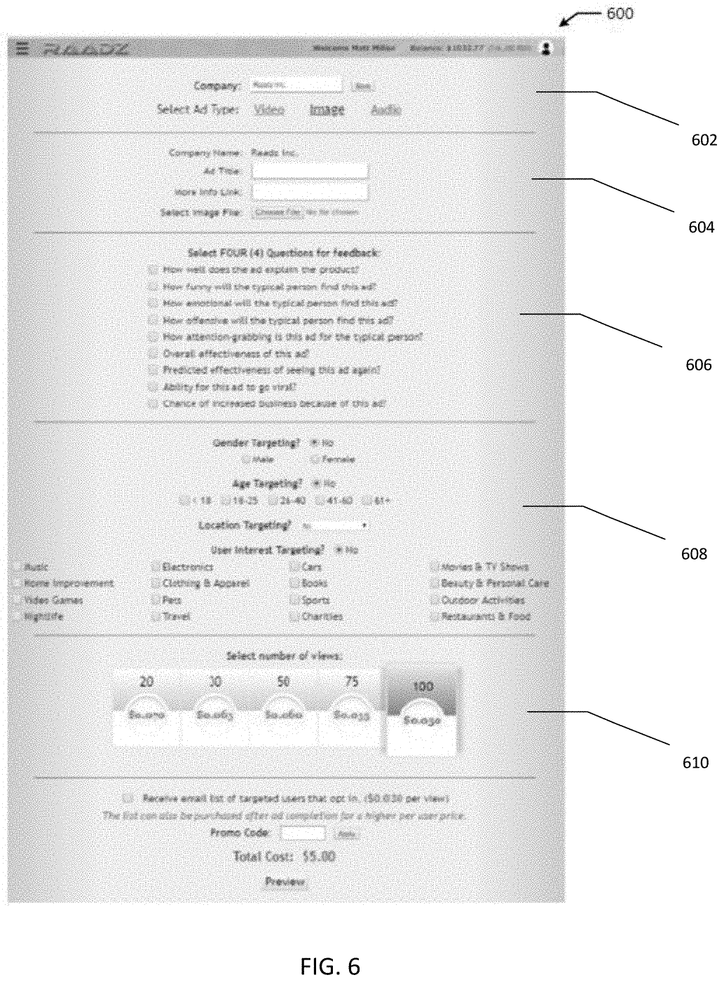

FIG. 6 shows an example advertiser platform interface 600, according to one aspect of the present disclosure. Advertisers desiring users 102, 104, 106 to rate their advertisements with the presently disclosed system, method, and apparatus may submit their advertisements using the example interface 600. The example interface 600 may include an ad type user interface 602 at which advertisers may choose the type of advertisement they would like to submit. The advertisement may be virtually any type of advertisement, for example, billboards, television ads, radio ads, newspaper and magazine ads, internet ads, pop-up ads, direct mail advertising, posters, displays, signs, banner ads, etc. The example interface 600 may also have a company information user interface 604 which may have entries for an advertiser to input information about the advertiser and the advertisement.

The example interface 600 may include a query user interface 606 for an advertiser to decide which queries 222, 226 the advertiser would like the users 102, 104, 106 to answer. In the illustrated embodiment, the query user interface 606 includes a list of queries 222, 226 from which an advertiser may choose. In other embodiments, the query user interface 606 may present input fields for an advertiser to type its own queries and/or possible answers. In other embodiments still, the query user interface 606 may present both a list of queries 222, 226 and one or more input fields. It should be appreciated that an advertiser may select or create any number of queries 222, 226 at the query user interface 606 when submitting an advertisement. The example interface 600 may also include a demographics user interface 608 at which the advertiser may select a number of options concerning the audience the advertiser is targeting. For example, the demographics user interface 608 may include an option for targeting a specific gender, or age, or location, or user interest. It should be appreciated, however, that any type of advertising demographic may be provided as an option on the demographics user interface 608.

The example interface 600 may also include a views selection user interface 610 at which an advertiser may select the number of views it would like to purchase. For example, the views selection user interface 610 illustrates that the advertiser may select either 20, 30, 50, 75, or 100 views. It should be appreciated, however, that any number of views may be offered on the views selection user interface 610 and/or there may be an input for selecting a custom number of views. The advertisement submitted will only be shown to the number of views purchased. Accordingly, the more views the advertiser purchases, the more data the advertiser will collect from users 102, 104, 106. In an alternate example, rather than selecting a certain number of users 102, 104, 106 or views for reviewing an ad 212, an advertiser may determine the feedback on a particular ad 212 may be open for a certain period of time, such as, for example, one week, two days, one hour, one year, etc.

### Method Embodiment

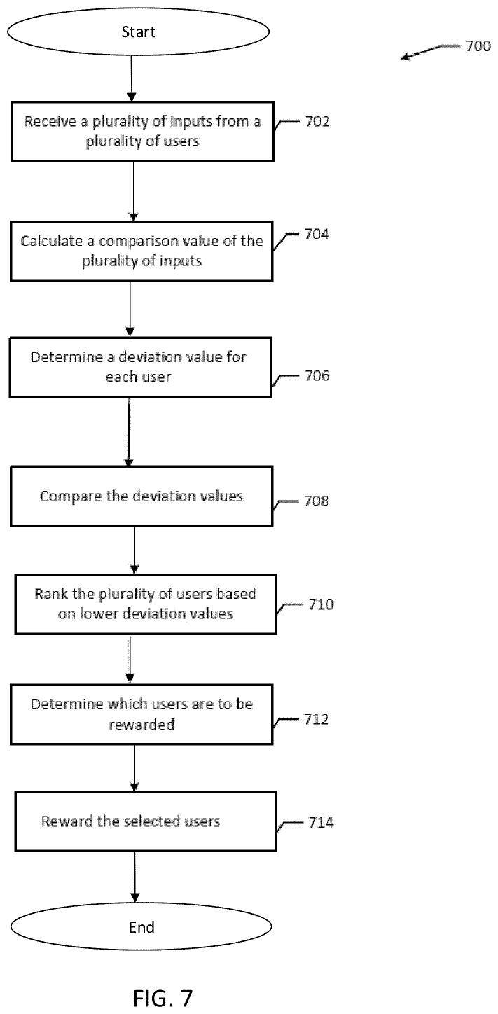

FIG. 7 shows an example method 700 for ranking users 102, 104, 106 that view and rate advertisements, according to an example embodiment of the present disclosure. The method 700 may be implemented on a computer system, such as the analysis server 114 and/or the devices 108, 110, 112. For example, the method 700 may be implemented by the item module 210, the query module 220, the comparison value calculator 230, the deviation value generator 240, and/or the reward module 250 of the analysis server 114. The method 700 may also be implemented by a set of instructions stored on a computer readable medium that, when executed by a processor, cause the computer system to perform the method. For example, all or part of the method 700 may be implemented by the CPU 206 and the memory 208. Although the examples below are described with reference to the flowchart illustrated in FIG. 7, many other methods of performing the acts associated with FIG. 7 may be used. For example, the order of some of the steps may be changed, certain steps may be combined with other steps, one or more of the steps may be repeated, and some of the steps described may be optional.

The example method 700 begins by receiving a plurality of answer values 224, 228 from a plurality of users (step 702). For example, as depicted in FIG. 1, a first user may be the user 102, a second user may be the user 104, and a third user may be the user 106. The user 102 may provide a first answer value 224, 228 via the device (computer) 108, the user 104 may provide a second answer value 224, 228 via the device (smart phone) 110, and the user 106 may provide a third answer value 224, 228 via a device (tablet) 112. The answer value 224, 228 provided by the users 102, 104 and 106 may correspond to answer value 224, 228 inserted in, for example, the answer user interface 210 in FIG. 2 or the answer user interface 308 in FIG. 3.

In the example, the user 102 may have been presented with the question interface 202 of FIG. 2 on the device 108, and input the number “77” in the answer user interface 210 after viewing advertisement 204. Similarly, in the example, the user 104 may have been presented with question interface 202 on device 110, and input the number “20” in the answer user interface 210 after viewing advertisement 204. Similarly, in the example, the user 106 may have been presented with the question interface 202 on the device 112, and input the number “37” in the answer user interface 210 after viewing the advertisement 204.

Next, a comparison value 232, 234 of the plurality of answer values 224, 228 may be calculated (step 704). A comparison value 232, 234 may be any number calculated from the plurality of answer values 224, 228 that is treated as a “typical” or “average” answer that the answer values 224, 228 of the users 102, 104, 106 may be compared to in order to determine if the users 102, 104, 106 gave thoughtful answers. For example, a comparison value 232, 234 may be the average, mean, or mode of a set of answer values 224, 228 given in response to a query 222, 226. In other embodiments, a comparison value 232, 234 may be an average of a set of answer values 224, 228 after any outliers are removed from the set. In some embodiments, a comparison value 232, 234 may be calculated from only the answer values 224, 228 received after presenting the ad 212 to a set number of users 102, 104, 106. In other embodiments, a comparison value 232, 234 may be calculated from a larger population of answer values 224, 228, for example, by including the answer values 224, 228 received after previously presenting the ad 212 to a different set of users 102, 104, 106 or to the general population. In other embodiments still, a comparison value 232, 234 may be calculated from historical data received when testing a different advertisement. Or, a comparison value 232, 234 may be a number chosen by an advertiser that the advertiser deems to be a thoughtful answer, according to an embodiment.

In some embodiments, a comparison value 232, 234 is not calculated until an answer value 224, 228 has been received from every user 102, 104, 106. In other words, a comparison value 232, 234 is calculated when the survey/feedback period is over and users 102, 104, 106 can no longer submit answer values 232, 234. In an alternative embodiment, a comparison value 232, 234 may be calculated when a threshold number of answer values 224, 228 has been received, even if more answer values 224, 228 are received after the threshold number is met. The calculated comparison value 232, 234 is not affected by the answer values 224, 228 received after the threshold number is met, in the alternative embodiment, and is used for the users 102, 104, 106 submitting the respective answer values 224, 228 after the threshold number is met.

In a non-limiting example, an advertiser may leave feedback open for two weeks. After one week, two hundred users 102, 104, 106 may submit answer values 224, 228 to the respective one or more queries 222, 226, which may be considered a threshold number of answer values 224, 228 sufficient to calculate a comparison value 232, 234. In the second week, one hundred more users 102, 104, 106 may submit answer values 224, 228; however, these answer values 224, 228 do not affect the already calculated comparison value 232, 234. The deviation values 242, 244 for each of the one hundred more users 102, 104, 106 are calculated based on the already calculated comparison value 232, 234 (as discussed in more detail below). In one aspect of the present disclosure, the threshold number of answers 224, 228 is a number of answer values 224, 228 sufficient to calculate a comparison value 232, 234 representative of a thoughtful answer. For example, fifty, one hundred, or two hundred answer values 232, 234 rather than one, two, or three answer values 232, 234. It should be appreciated, however, that the threshold number of answer values 224, 228 may be any number. It should also be appreciated that the threshold number may be of users 102, 104, 106 rather than answer values 224, 228, in some embodiments.

As previously discussed, a comparison value 232, 234 is meant to represent a truthful or thoughtful answer that the answer values 224, 228 of users 102, 104, 106 may be compared against. A user 102, 104, 106 does not know what the comparison value 232, 234 is for any given query 222, 226. In some embodiments, as discussed above, the comparison value 232, 234 is not calculated until all answer values 224, 228 are submitted from all users 102, 104, 106 and thus is not even calculated at the time a user 102, 104, 106 submits his or her answer value 224, 228. Therefore, if a query 222, 226 shown to fifty users 102, 104, 106 presents a scale from 0-100 for how effective a user 102, 104, 106 thought the ad 212 was, those fifty users 102, 104, 106 will choose many different answer values 224, 228 if answered thoughtfully. Sometimes the answer values 224, 228 received may be clustered in a certain range because the users 102, 104, 106 had similar opinions. Other times, the answer values 224, 228 may be over a wide range because the users 102, 104, 106 had differing opinions.

It is not likely, however, that most or all users 102, 104, 106 will select “0” or “100” on the scale and therefore the comparison value 232, 234 will likewise not be “0” or “100” for a query 222, 226. A user 102, 104, 106 who is careless when answering the query 222, 226 and quickly enters “0” or “100,” or quickly enters random numbers for a series of queries 222, 226, therefore runs the risk of not being near the comparison value or values 232, 234 and not obtaining the reward. Rather, the disclosed system, method, and apparatus incentivizes users 102, 104, 106 to answer the queries 222, 226 thoughtfully and carefully in order to attempt to be near the comparison value 232, 234 and obtain the reward. Accordingly, it should be appreciated that the comparison value 232, 234 may be calculated in any manner such that the calculated value serves this purpose of a thoughtful answer.

Continuing with the example in which the user 102 input the number “77,” the user 104 input the number “20,” and the user 106 input the number “37,” the comparison value 232, 234 may be the average of the three numbers in some embodiments. For example, 77, 20, and 37 are added, and then the total will be divided by three, as there are three users. Therefore, the average is 44.667. Rounding up, the average is 45. This average may be calculated by the analysis server 114. It should be appreciated that the analysis server 114 may execute all comparison value 232, 234 calculations. The analysis server 114 may use the exact average (e.g., 44.667), the nearest whole number average (e.g., 45), or the base number average (e.g., 44) when determining the average. It should be appreciated that if the exact average is directly in between two whole numbers (e.g., 44.5), then the analysis server 114 may either round up to 45 or round down to 44 in various embodiments. In this example, the analysis server 114 will use the nearest whole number average (e.g., 45).

It should also be understood that, in various embodiments, more than one query 222, 226 will be presented to the users 102, 104, 106 for a given ad 212. In such embodiments, a comparison value 232, 234 is calculated for each query 222, 226. For example, if thirty users 102, 104, 106 are presented with query 222 and query 226 in response to ad 212, then a comparison value 232 is calculated for the thirty answer values 224 in response to query 222 and a comparison value 234 is calculated for the thirty answer values 228 in response to query 226. It should be appreciated that any number of queries 222, 226 may be presented and a comparison value 232, 234 will be calculated for each one.

Next, a deviation value 242, 244 is generated for each user 102, 104, 106 based on the comparison value 232, 234 calculated (step 706). A deviation value 242, 244 may be the difference between the answer value 222, 226 of a user 102, 104, 106 and the comparison value 232, 234, according to an aspect of the present disclosure. For example, continuing with the example in which the comparison value 232, 234 calculated was “45,” a deviation value 242, 244 for the first answer value 224, 228 (“77”) by the first user 102 is “32.” A deviation value 242, 244 for the second answer value 224, 228 (“20”) by the second user 104 is “25.” A deviation value 242, 244 for the third answer value 224, 228 (“37”) by the third user 106 is “8.” The deviation values 242, 244 may be calculated by the analysis server 114.

It should be understood that in various embodiments in which more than one query 222, 226 is presented to the users 102, 104, 106, a deviation value 242, 244 is generated for each query 222, 226 for the first user 102, for each query 222, 226 for the second user 104, and for each query 222, 226 for the third user 106. In such embodiments, the deviation values 242, 244 for the first user 102 are added together to generate a total deviation value. The same is done for the second user 104 and the third user 106. It should be appreciated that the disclosed system, method, and apparatus may be used with any number of users 102, 104, 106 and the above example is merely for illustrative purposes.

The deviation values 242, 244 are then compared (step 708), and the users 102, 104, 106 are ranked based on lower deviation values 242, 244 (step 710). For example, the first deviation value 242, 244 of “32” for the first user 102 is greater than the second deviation value 242, 244 of “25” for the second user 104. Further, the second deviation value 242, 244 of “25” for the second user 104 is greater than the third deviation value 242, 244 of “8” for the third user 106. Therefore, these deviation values 242, 244 are compared to rank the users 102, 104, 106. The users 102, 104, 106 with the lowest deviation value 242, 244 may be at the top of the ranking, as they may have the better score. Therefore, in this example, the third user 106 may come in first place, the second user 104 in second place, and the first user 102 in third place.

The rankings may be utilized to determine which users 102, 104, 106 should be rewarded for their participation according to a reward scheme 254 (step 712). For example, a reward scheme 254 may require that only the first place user 102, 104, 106 be rewarded. Alternately, the lowest 10%, 20%, 30% etc. of deviation values 242, 244 may be rewarded. For example, an advertiser may only be concerned with extreme outliers and may reward the lowest 90% of deviation values 242, 244, only excluding 10% of users 102, 104, 106, according to an embodiment. In an alternate example, the top five users may be rewarded. In another example, a first set of users with the lowest deviation values 242, 244 (e.g., lowest 10%) may receive a first reward, a second set of users with the next lowest deviation values 242, 244 (e.g., lowest 11-20%) may receive a second, different reward, and so on for any number of sets of users.

By only rewarding a portion of the participating users 102, 104, 106, there may be further incentive for the users 102, 104, 106 to provide thoughtful answer values 222, 226 in order to attempt to have the lowest deviation value 242, 244. Accordingly, it should be appreciated that any reward scheme 254 may be used to generate that incentive by only rewarding a portion of the participating users 102, 104, 106. An example reward scheme 254 is detailed in the following paragraphs.

Based on User Rank, a Video Ad May Pay:
Top 5% of users: $1.00
Top 5%-10% of users: $0.75
Top 10%-15% of users: $0.50
Top 15%-25% of users: $0.25

Based on User Rank, an Image Ad May Pay:
Top 5%: $0.50
Top 5%-10%: $0.25

Based on User Rank, an Audio Ad May Pay:
Top 5%: $0.75
Top 5%-10%: $0.50
Top 10%-15%: $0.25

It should also be understood that in various embodiments in which more than one query 222, 226 is presented to the users 102, 104, 106, the users 102, 104, 106 will be ranked according to their total deviation values. As such, the reward scheme 254 described above will apply in the same manner to the ranking of total deviation values as it does to the ranking of deviation values 242, 244.

For example, the Table 1 below illustrates the answer values 224, 228 for the users 102, 104, and 106 in response to four queries 222, 226 (i.e., Q1-Q4). The users 102, 104, and 106 had to answer on a 1-100 scale after viewing the ad in the example and the comparison value 232, 234 for each query 222, 226 was calculated as the average of the answer values 224, 228 received. The comparison values 232, 234 for the four queries 222, 226 were calculated as 75, 76, 74, and 75 respectively.

TABLE 1
Example User Query Answers:

| USER | Q1 | Q2 | Q3 | Q4 |
|---|---|---|---|---|
| 102 | 70 | 75 | 65 | 71 |
| 104 | 74 | 75 | 78 | 80 |
| 106 | 81 | 78 | 79 | 74 |
| AVERAGE | 75 | 76 | 74 | 75 |

Table 2 below illustrates the determined deviation values 242, 244 for each user 102, 104, and 106 for each query 222, 226. For example, the user 102 has an answer value of “70” for query 1 (i.e., Q1) and the comparison value 232, 234 for Q1 is “75.” Therefore, the deviation value 242, 244 for the user 102 for Q1 is “5.” Table 2 also illustrates the total deviation values for each user 102, 104, and 106. The total deviation value for each user 102, 104, 106 is the sum of their deviation values 242, 244 for each query 222, 226. Based on the determined total deviation values in this example, the user 104 had the lowest total, the user 106 had the second lowest total, and the user 102 had the highest total.

TABLE 2
Example User Scores (sum of individual queries):

| USER | Q1 | Q2 | Q3 | Q4 | TOTALS |
|---|---|---|---|---|---|
| 102 | 5 | 1 | 9 | 4 = | 19 |
| 104 | 1 | 1 | 4 | 5 = | 11 |
| 106 | 6 | 2 | 5 | 1 = | 14 |

After it is determined which users 102, 104, 106 should be rewarded, those determined users 102, 104, 106 are rewarded (step 714). For example, the advertisers, the platform, or the operators of the platform may determine that the lowest score (e.g., the third user 106) will receive $1.00, and the second lowest score (e.g., the second user 104) will receive $0.50. Thus, users 104 and 106 may be provided these rewards by the platform, operators of the platform, or the advertisers directly. It should be appreciated that the reward can also be gift cards, credits, goods, etc. in addition to money.

In many embodiments, a reward is not provided to any users 102, 104, 106 until after the feedback period is over and all users 102, 104, 106 are ranked based on their calculated deviation values 242, 244 or total deviation values. In an alternative embodiment, a reward may be provided to a user 102, 104, 106 immediately, or soon thereafter, if a deviation value 242, 244 of zero is determined for the user 102, 104, 106. This is with the understanding that a user 102, 104, 106 cannot do better than a deviation value 242, 244 of zero and thus is guaranteed a reward. It should also be appreciated that other deviation values 242, 244 or total deviation values may be chosen as an automatic reward benchmark other than zero (e.g., 1, 2, 3, . . . 10, etc.). For example, in instances when a comparison value 232, 234 is calculated prior to the feedback period closing, if a user 102, 104, 106 then submits one or more answer values 224, 228, a deviation value 242, 244 or total deviation value may be determined for that user 102, 104, 106 prior to the feedback period closing. If the deviation value 242, 244 or total deviation value for that user 102, 104, 106 is determined to be at or below the automatic reward benchmark, then the user 102, 104, 106 may automatically receive a reward and does not have to wait until the feedback period closes.

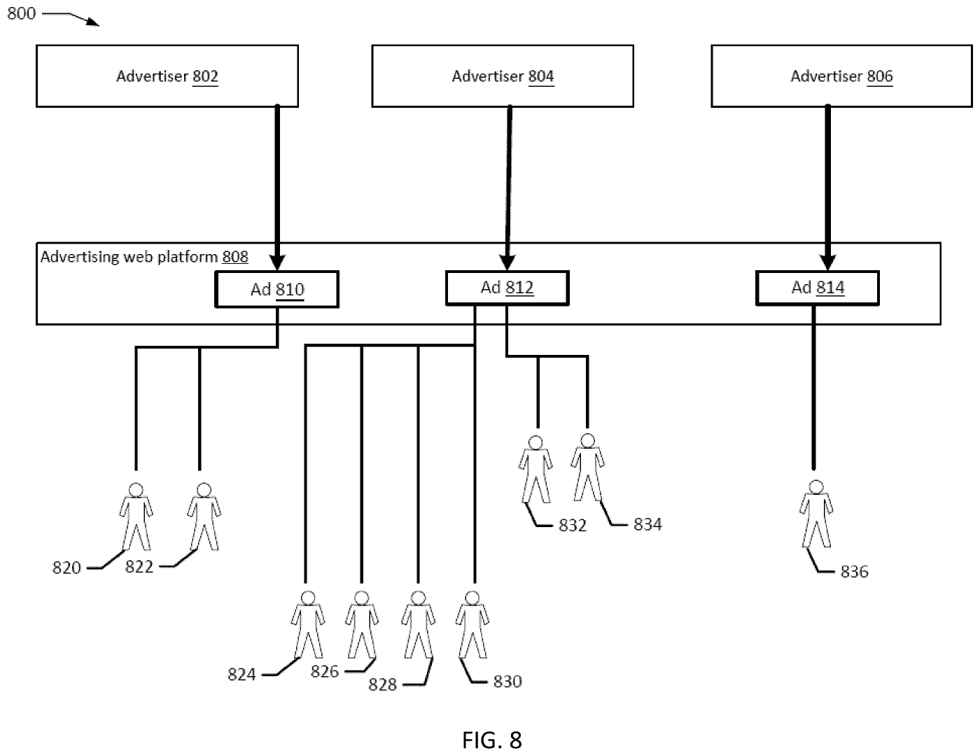

FIG. 8 shows an example diagram of a system for rewarding and ranking users that view advertisements, according to one aspect of the present disclosure. In the example, the advertisers 802, 804, and 806 may provide advertisements that they would like to reward users for watching and answering queries 222, 226 about. These advertisements, or Ads 810, 812, and 814 are placed onto an advertising web platform 808 either directly by the advertisers 802, 804, 806 (e.g., using the example advertiser platform interface 600) or indirectly by a party controlling access to the advertising web platform 808. In the example, the advertiser 802 placed the Ad 810 onto the advertising web platform 808, while the advertisers 804 and 806 provided their Ads 812 and 814, respectively, to a third party to place onto the advertising web platform 808.

The advertisers 802, 804, and 806 in the example, may provide instructions as to how many users 102, 104, 106 may view ads 212, how many users 102, 104, 106 may answer a specific set of queries 222, 226, how many results are required before receiving a reward, who the target audience is for each advertisement, etc. For example, the advertiser 802 may specify that only two users, the users 820 and 822, are needed to view and answer questions regarding the Ad 810. Or, in an alternate example, the advertiser 802 may have specified that seven females should review the Ad 810. In this alternative example, the advertising web platform 808 may be waiting for five more females to sign into the web platform 808 and answer questions regarding the Ad 810 before beginning computations for one or more comparison values 232, 234. It should be appreciated that, rather than selecting a certain number of users 102, 104, 106 for reviewing an ad 212, an advertiser may also determine the feedback on a particular ad 212 may be open for a certain period of time, such as, for example, one week, two days, one hour, one year, etc.

The advertiser 804, in the example, may have specified two separate sets of queries 222, 226 regarding the Ad 812, and therefore required two groups of user 102, 104, 106. The advertiser 804 may have specified that one group may contain four users 824, 826, 828, and 830, and the average should be calculated for the comparison value 232, 234 with the reward going to the one user with the lowest deviation value 242, 244 from the average, according to an embodiment. The advertiser 804 may have also specified that the second set of queries 222, 226 only requires two users 832 and 834, and they both will receive rewards regardless of their answer values 224, 228, according to an embodiment.

Continuing with the example, the advertiser 806 may have specified only one user 836 may view and answer queries 222, 226 relating to the Ad 814. Therefore, the user 836 may automatically receive a reward. It should be appreciated that any number of users 102, 104, 106 may be utilized by advertisers in answering queries 222, 226 related to viewed ads 212. For example, there may be 50, 100, 10,000 users, etc. that answer queries 222, 226 for advertisers.

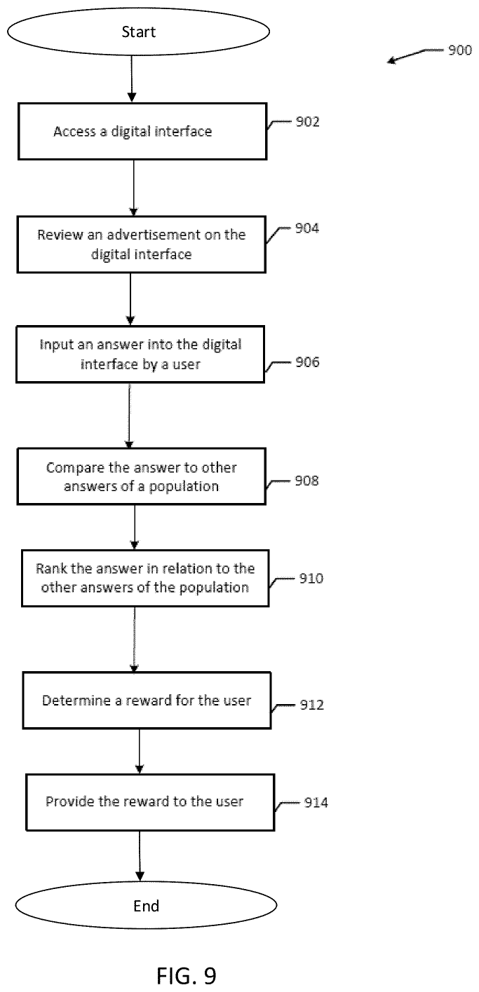

FIG. 9 illustrates an example method 900 for using a system for ranking and rewarding users that view advertisements, according to one aspect of the present disclosure. The method 900 may be implemented on a computer system, such as the analysis server 114 and/or the devices 108, 110, 112. For example, the method 900 may be implemented by the item module 210, the query module 220, the comparison value calculator 230, the deviation value generator 240, and/or the reward module 250 of the analysis server 114. The method 900 may also be implemented by a set of instructions stored on a computer readable medium that, when executed by a processor, cause the computer system to perform the method. For example, all or part of the method 900 may be implemented by the CPU 206 and the memory 208. Although the examples below are described with reference to the flowchart illustrated in FIG. 9, many other methods of performing the acts associated with FIG. 9 may be used. For example, the order of some of the steps may be changed, certain steps may be combined with other steps, one or more of the steps may be repeated, and some of the steps described may be optional.

The example method begins by accessing a digital interface (step 902). For example, a user such as the user 102 in FIG. 1 may access a digital interface such as digital interface (computer) 108. Next, an ad 212 is reviewed on the digital interface (step 904). For example, the user 102 may review an ad 212 on the digital interface (computer) 108. This may be by accessing a website, portal, application, or program loaded onto or accessible via the digital interface (computer) 108. The user 102 may, for example, be viewing the banner advertisement 404 of FIG. 4 on the digital interface (computer) 108.

In various embodiments, an answer value 224, 228 is then input into the digital interface by a user (step 906). For example, the user 102 may select/input an answer value 224, 228 from the answer user interface 408 about the viewed banner advertisement 404 after reviewing a question prompt 406. Next, the answer value 224, 228 is compared to other answer values 224, 228 of a population (step 908). For example, if answer D is selected from the answer user interface 408 by the user 102, the answer values 224, 228 selected by other user 102, 104, 106 (the population) may be compared to the answer values 224, 228 of the user 102. Advertisers may select as many user 102, 104, 106 as desired to review ads 212 and provide feedback. For example, the answer values 224, 228 of the population may include answer values 224, 228 from the user 104 and the user 106. The answer values 224, 228 of the user 104 and the user 106 may be compared to the answer values 224, 228 of the user 102. This comparison may include taking the average of all the answers values 224, 228, and calculating a deviation value 242, 244 from the average for each answer value 224, 228. It should be appreciated that the comparison may include any of the previously discussed methods for calculating comparison values 232, 234 and deviation values 242, 244. In an alternate example, rather than selecting a certain number of users 102, 104, 106 for reviewing an ad 212, an advertiser may determine the feedback on a particular ad 212 may be open for a certain period of time, such as, for example, one week, two days, one hour, one year, etc.

Next, the answer value 224, 228 is ranked in relation to the other answer values 224, 228 of the population (step 910). For example, the participants in the population (the users 104 and 106) and the user 102 may be ranked according to their deviation values 242, 244 calculated previously. The participant with the lowest deviation score may have the “best” score. In this example, the user 102 may be in the top 20% of lowest deviation scores, but not in the top 10% as compared to the population (e.g., including the users 104 and 106).

Next, a reward is determined for the user 102, 104, 106 (step 912). In the example, the users 102, 104, 106 (population) with the top 10% of lowest deviation values 242, 244 may receive $0.50, and the participants not in the top 10% but in the top 20% of lowest deviation values 242, 244 may receive $0.25. Therefore, it may be determined that the user 102 may receive $0.25, as the user 102's scores are in the top 20% of lowest deviation values 242, 244. Next, the reward is provided to the user 102, 104, 106 (step 914). In the example, the user 102 may receive $0.25.

### CONCLUSION

Without further elaboration, it is believed that one skilled in the art can use the preceding description to utilize the claimed inventions to their fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles discussed. In other words, various modifications and improvements of the embodiments specifically disclosed in the description above are within the scope of the appended claims. For example, any suitable combination of features of the various embodiments described is contemplated. The scope of the invention is therefore defined by the following claims.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of rewarding users for completing reviews, comprising:
causing, via a processor, an item to be presented at a plurality of user devices to a plurality of users during a feedback session that is related to the item;
receiving, in the processor from the user devices, an answer value from each of the plurality of users in response to a query included in or regarding the item;
calculating, via the processor, a comparison value for the answer values from the plurality of users;
determining, via the processor, for each of the users, a deviation value between the respective answer value for each user and the comparison value;
ranking, via the processor, the plurality of users based on the respective deviation values such that a lower ranking corresponds to a lower deviation value; and
causing, via the processor, a reward to be provided to at least one user associated with the lower ranking.

2. The method of claim 1, wherein the comparison value is an average, median, or mode of the answer values from each of the users.

3. The method of claim 1, wherein the reward is provided to the user with the lowest deviation value.

4. The method of claim 1, wherein the reward is provided to a set of users with deviation values below a threshold.

5. The method of claim 1, further comprising causing, via the processor, a first reward to be provided to a first set of users with lower deviation values compared to a second set of users, and a second reward, different than the first reward, to be provided to the second set of users.

6. The method of claim 1, wherein the item is one or more of an advertisement, a video, an image, a sound, a portion of text, a movie, a book, a survey, a questionnaire, a product design, or a logo.

7. The method of claim 1, wherein the deviation value for each user is the difference between the answer value of the respective user and the comparison value.

8. The method of claim 1, wherein the comparison value is calculated once a feedback period concludes and all of the answer values are received.

9. The method of claim 8, wherein the feedback period concludes after a number of answer values are received or an amount of time elapses.

10. The method of claim 1, wherein the comparison value is calculated after a threshold number of answer values is received and the feedback period remains open after the comparison value is calculated.

11. The method of claim 10, wherein the comparison value is calculated from only the answer values received prior to, and contemporaneous with, the threshold number of answer values being received.

12. The method of claim 11, wherein the deviation value for each of the users whose respective answer values are received after the threshold number of answer values is received is determined between the respective answer value for each user and the comparison value calculated from only the answer values received prior to, and contemporaneous with, the threshold number of answer values being received.

13. The method of claim 10, wherein a deviation value is determined for each of the plurality of users, and the plurality of users are ranked, after the feedback period concludes.

14. The method of claim 10, wherein after the comparison value is calculated, a deviation value is determined for each of the plurality of users as the respective answer value for each user is received.

15. The method of claim 14, wherein a reward is provided to a user prior to the feedback period concluding if a deviation value of zero is determined for the user.

16. The method of claim 1, comprising:
receiving, via the user interface, a set of answer values from each of the plurality of users in response to a plurality of queries included in or regarding the item;
calculating, via the processor for each query, a comparison value for the respective answer values received for each query from the plurality of users;
determining, via the processor for each of the users, a total deviation value, wherein the total deviation value is a sum of the deviation values determined for each of the users for the plurality of queries;
ranking, via the processor, the plurality of users based on the respective total deviation values such that a lower ranking corresponds to a lower total deviation value;
causing, via the processor, a reward to be provided to at least one user.

17. An apparatus for rewarding users for completing reviews, comprising:
a processor; and
memory storing instructions which, when executed by the processor, cause the processor to:
cause an item to be presented at a plurality of user devices to a plurality of users during a feedback session;
receive, via the user devices, an answer value from each of the plurality of users in response to a query included in or regarding the item;
calculate a comparison value for the answer values from the plurality of users;
determine, for each of the users, a deviation value between the respective answer value for each user and the comparison value;
rank the plurality of users based on the respective deviation values such that a lower ranking corresponds to a lower deviation value; and
cause a reward to be provided to at least one user.

18. The apparatus of claim 17, wherein the comparison value is an average, median, or mode of the respective answer values for a query.

19. The apparatus of claim 17, wherein the reward is provided to a set of users with total deviation values below a threshold.

20. The apparatus of claim 17, wherein the memory stores additional instructions which, when executed by the processor, cause the processor to:
receive, via the user interface, a set of answer values from each of the plurality of users in response to a plurality of queries included in or regarding the item;
calculate, for each query, a comparison value for the respective answer values received for each query from the plurality of users;
determine, for each of the users, a total deviation value, wherein the total deviation value is a sum of the deviation values determined for each of the users for the plurality of queries;
rank the plurality of users based on the respective total deviation values such that a lower ranking corresponds to a lower total deviation value;
cause a reward to be provided to at least one user.
